(19) United States
(12) Patent Application Publication
(10) Pub. No.: US 2024/0326865 A1
(43) Pub. Date: Oct. 3, 2024

(54) SYSTEMS AND METHODS FOR IMPROVING VEHICLE OPERATION BASED ON DATA CAPTURED FROM EVENT AND CONVENTIONAL CAMERAS

(71) Applicant: Honda Motor Co., Ltd., Tokyo (JP)

(72) Inventors: Samir K. Al-Stouhi, Dearborn, MI (US); Paritosh S. Kelkar, Sunnyvale, CA (US)

(21) Appl. No.: 18/191,667

(22) Filed: Mar. 28, 2023

(51) Int. Cl. B60W 60/00; B60W 30/09; B60W 50/14; G06T 7/292; H04N 5/262; H04N 23/66

(52) U.S. Cl. CPC B60W 60/0015; B60W 30/09; B60W 50/14; G06T 7/292; H04N 5/2628; H04N 23/66; B60W 2050/143; B60W 2050/146; B60W 2420/403; B60W 2554/404; B60W 2556/45; G06T 2207/20081; G06T 2207/30252

(57) ABSTRACT

Provided herein is a vehicle including an event camera coupled to the vehicle, a conventional camera coupled to the vehicle, and a control unit communicatively coupled to the event camera and to the conventional camera. The control unit is configured to: receive, from the event camera when the event camera senses movement of at least one object from the surroundings of the vehicle, movement data associated with the at least one object, instruct, based upon the movement data, the conventional camera to capture an image of the at least one object, and analyze the movement data and the captured image to determine whether the at least one object is an object of interest.

### BACKGROUND

The present disclosure relates generally to event and conventional cameras, and more specifically, to systems that facilitate improving vehicle operation based on data captured from event and conventional cameras during operation of a vehicle.

As more vehicles are able to operate with higher levels of autonomy, the amount of processing power needed for autonomous driving of vehicles has increased steadily. At least some known vehicle systems include sensors that constantly scan the surroundings of the vehicle as the vehicle navigates, and vehicle systems receiving data from those sensors analyze the sensor data to determine if changes are needed to the navigation of the vehicle (e.g., if objects or people are on course to collide with the vehicle). For example, in currently available systems, images are continuously captured by conventional cameras located on the vehicle, and local or remote processing devices analyze the captured image data to facilitate improving the safety and operation of the vehicle. Analyzing images and data is necessary for safe autonomous operation of the vehicle. However, processing the continuous steam of images and data in real-time requires a high amount of processing power. Accordingly, it would be desirable to provide a system that can improve vehicle operations by analyzing image data of the surroundings of the vehicle in an efficient manner during operation of the vehicle.

### BRIEF DESCRIPTION

In one aspect, a vehicle including an event camera coupled to the vehicle, a conventional camera coupled to the vehicle, and a control unit communicatively coupled to the event camera and to the conventional camera is provided. The control unit is configured to receive, from the event camera when the event camera senses movement of at least one object from the surroundings of the vehicle, movement data associated with the at least one object; instruct, based upon the movement data, the conventional camera to capture an image of the at least one object; and analyze the movement data and the captured image to determine whether the at least one object is an object of interest.

In another aspect, a vehicle sensing system of a vehicle including (i) an event camera coupled to the vehicle, (ii) a conventional camera coupled to the vehicle, and (iii) a control unit communicatively coupled to the event camera and to the conventional camera is provided. The control unit is configured to: receive, from the event camera when the event camera senses movement of at least one object from the surroundings of the vehicle, movement data associated with the at least one object; instruct, based upon the movement data, the conventional camera to capture an image of the at least one object; analyze the movement data and the captured image to determine whether the at least one object is an object of interest; and transmit, to a driving system of the vehicle, a signal corresponding to a determination that the at least one object is an object of interest.

In yet another aspect, a method for enhancing operation of a vehicle is provided. The method includes receiving, by a control unit of a vehicle, from an event camera of the vehicle when the event camera senses movement of at least one object from the surroundings of the vehicle, movement data associated with the at least one object; instructing, by the control unit, based upon the movement data, a conventional camera of the vehicle to capture an image of the at least one object; and analyzing, by the control unit, the movement data and the captured image to determine whether the at least one object is an object of interest.

### BRIEF DESCRIPTION OF THE DRAWINGS

FIG. 1 illustrates an exemplary vehicle integrated with a system for use in analyzing data in real-time using event and conventional cameras.

FIG. 2 is a schematic illustration of an exemplary network architecture that may be used with the system shown in FIG. 1.

FIG. 3 is a data flow diagram illustrating exemplary data flow between components of the system shown in FIG. 1 and the network architecture shown in FIG. 2.

FIG. 4A illustrates exemplary movement data that may be captured by an event camera; FIG. 4B illustrates an exemplary image that may be captured by a conventional camera based on the movement data of FIG. 4A; FIG. 4C illustrates exemplary identification of where movement takes place in the image of FIG. 4B based on the movement data of FIG. 4A; and FIG. 4D illustrates an exemplary cropped image of the identified movement of FIG. 4C.

### DETAILED DESCRIPTION

The systems and methods described herein are intended to improve the operation of a vehicle using data captured from event and conventional cameras coupled to or integrated within the vehicle to provide real-time image analysis of surroundings about the vehicle while the vehicle is in operation (e.g., either manual, semi-autonomous, or fully autonomous operation). In the exemplary embodiment, each event camera transmits movement data to a control unit associated with the vehicle. If the movement of one or more objects is detected by an event camera, the control unit causes the conventional camera to capture an image of the object(s). The image of the object(s) is then analyzed by the control unit and/or transmitted to a remote processing device by the control unit. The analysis of the image of the object(s) is used to determine whether operation of the vehicle requires change (e.g., stopping/swerving to avoid colliding with the objects).

Machine learning and/or artificial intelligence techniques may be used to generate one or more models to analyze the movement data and the image data. For example, the models may be trained using historical data to be used by the control unit to determine whether movement data and/or image data of moving objects requires further analysis. Because the systems and methods described herein use movement data from an event camera before analyzing any images from a conventional camera, processing power and resources are used more efficiently and are generally less or saved as compared to an amount of processing power necessary to constantly analyze image data from conventional cameras. Accordingly, with the system described herein, processing power is used sparingly and communication channels between the control unit and remote processing devices can be used more efficiently.

As used herein, the terms “autonomous operation” and/or “semi-autonomous operation” relate to any type of vehicle control system and/or vehicle augmentation system that facilitates enhancing the driving experience and capabilities of a vehicle. For example, vehicle control and augmentation systems may include operating a steering wheel of a vehicle while the vehicle is set on cruise-control, autonomously operating a vehicle while the vehicle is on an interstate or highway, operating the vehicle in a fully autonomous or “self-driving” mode (e.g., where a driver inputs a location for the vehicle and the vehicle drives to the location without assistance from the driver), and any other vehicle control or augmentation system.

As used herein, the terms “event camera(s)” and/or “neuromorphic camera(s)” relate to any cameras or image sensors configured to detect movement and differences between two images and capture movement data associated with the detected movement. That is, if objects included in the field of view of the event camera do not move, the camera will not detect any movement and therefore will not capture any movement data of the objects. Event cameras typically are not time-stamped or include an internal clock, operate at around 1000 Hz, and utilize little power due as no processing occurs when there is no movement detected in the field of view of the camera.

Further, as used herein, the term “conventional camera” relates to any camera with a shutter and lens that is configured to capture images. The conventional camera may be configured to capture images when instructed, or the conventional camera may be configured to capture images at a near-constant rate (e.g., 30 frames per second).

Moreover, as used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

Furthermore, as used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

In addition, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

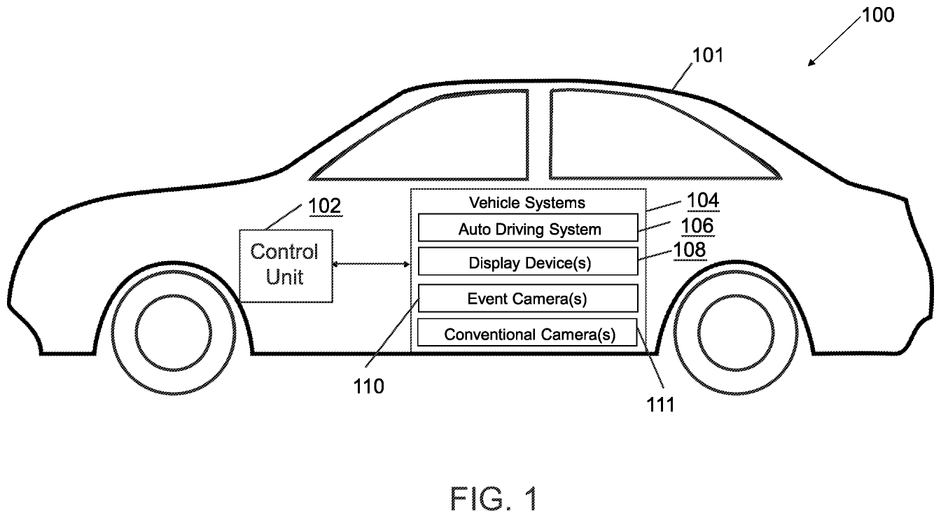

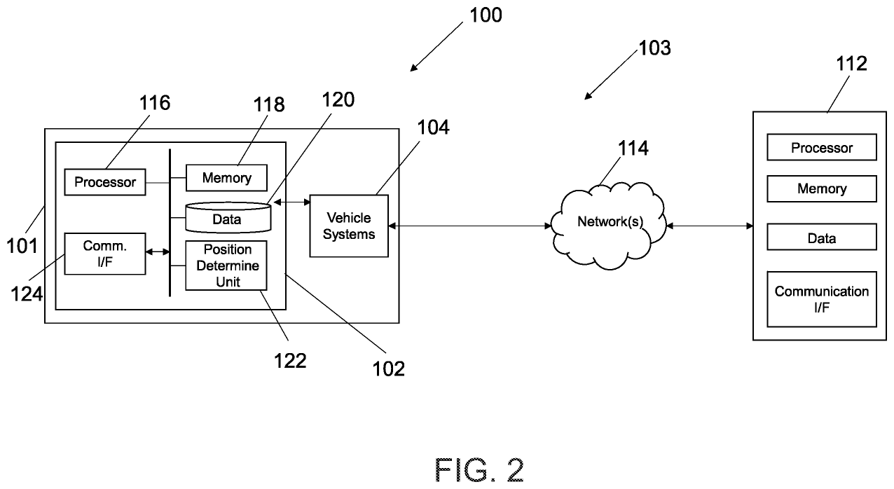

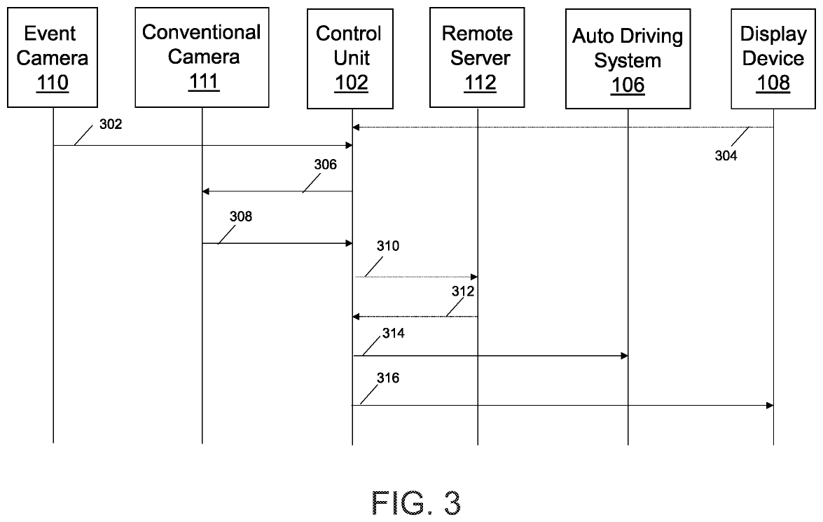

Referring now to the drawings, FIG. 1 is an exemplary vehicle 101 integrated with an exemplary system 100 that may be used in analyzing movement data and image data for one or more moving objects in the immediate surroundings of vehicle 101. FIG. 2 is a schematic illustration of an exemplary network architecture 103 that may be used with system 100. FIG. 3 is an exemplary data flow diagram showing exemplary data flows between elements of system 100 and network architecture 103. In the exemplary embodiment, system 100 analyzes movement data and image data for moving objects in the surroundings of vehicle 101, as described in more detail herein. System 100 can be implemented with the components shown in FIG. 1, but is not limited to only being implemented using the components illustrated in FIG. 1. For convenience, identical names and numerals are used in FIGS. 1-3 to identify the same components identified in each figure.

Referring to FIG. 1, in the exemplary embodiment, vehicle 101 includes a control unit 102 and a plurality of vehicle systems 104. Vehicle systems 104 can include any type of vehicle control system and/or augmentation system that facilitates enhancing the driving experience and capabilities of vehicle 101. In the exemplary embodiment, vehicle systems 104 include at least an autonomous driving system 106, one or more display devices 108, one or more event cameras 110, and one or more conventional cameras 111. Alternatively, systems 104 may include any or all of the devices described herein, and/or in addition, may include other systems and/or devices that enable vehicle 101 to be operated in an autonomous or semi-autonomous driving mode, as described herein. For example, autonomous driving system 106 may include any autonomous driving systems, driver-assist systems, adaptive cruise control systems, lane departure warning systems, merge assist systems, freeway merging, exiting, and lane-change systems, collision warning systems, integrated vehicle-based safety systems, and automatic guided vehicle systems, and/or any other advanced driving assistance systems (ADAS).

Display device 108 may include any device that is configured to display information to a driver of vehicle 101, or in the case of autonomous driving operation, display information to a person seated in the driver's seat. For example, display device 108 may include a dashboard display oriented to display one or more vehicle properties to the driver of vehicle 101, including, for example, a speed of vehicle 101, revolutions per minute of an engine or drivetrain of vehicle 101, a relative temperature of an engine or drivetrain of vehicle 101, a status display of the current operation state of the vehicle 101 and/or a status display of the autonomous operation of vehicle 101, vehicles surrounding vehicle 101 and/or obstructions in close proximity to vehicle 101, alerts associated with vehicle 101, and any other vehicle properties. Event camera 110 may include any neuromorphic camera configured to detect movement in the surroundings of vehicle 101, as described herein. Conventional camera 111 may include any type of conventional camera including a lens and a shutter configured to capture an image from the surroundings of vehicle 101, as described herein. While event camera 110 and conventional camera 111 may each be referred to herein as a singular “camera,” it should be understood that vehicle systems 104 may include a plurality of event cameras 110 and/or conventional cameras 111 that function substantially similarly as a group of cameras 110 and 111 as cameras 110 and 111 would function as individual cameras 110 and 111. In some embodiments, vehicle 101 may receive input from additional sensors such as, but not limited to LIDAR, radar, and/or proximity detectors, that are used to provide additional information about the surroundings of vehicle 101, such as, but not limited to, other vehicles including the vehicle type and the vehicle load, obstacles, traffic flow information including road signs, traffic lights, and other traffic information, and/or other environmental information, including current weather conditions.

Referring now to FIG. 2, vehicle 101 and a remote server 112 (e.g., a cloud computing device 112) are operatively coupled together to enable communication therebetween. For example, vehicle 101 and a remote cloud computing processor 112 may communicate with each other via a network 114, or may be capable of communicating directly with each other via a wireless network (not shown). For simplicity, only one vehicle 101 is illustrated in FIG. 2. However, it should be understood that additional vehicles can be integrated with and include any of the components and/or functions described herein with respect to vehicle 101. Further, it should also be understood that the components of vehicle 101 and the remote server 112, as well as the components of other systems, hardware architectures, and software architectures discussed herein, can be combined, omitted, and/or organized into different architectures for various embodiments, without changing the scope of the disclosure.

In the exemplary embodiment, vehicle 101 includes a controller or control unit 102 and vehicle systems 104. Generally, controller 102 includes a processor 116, a memory 118, a data storage 120, a position determination unit 122 (labeled “position determine unit” in FIG. 2), and a communication interface (I/F) 124 (i.e., a transceiver 124), all of which are operably coupled for communication via a bus and/or other wired and/or wireless technologies discussed herein. Control unit 102 can include provisions for processing, communicating, and interacting with various components of vehicle 101 and other components of system 100, including any other vehicles within communicative proximity, and remote server 112.

Processor 116 includes logic circuitry with hardware, firmware, and software architecture frameworks that enable processing by vehicle 101 and that facilitate communication between any other vehicles and remote server 112. Processor 116 is programmed with an algorithm that analyzes movement data from event camera 110 and image data from conventional camera 111 to determine one or more objects of interest and whether the data should be further analyzed, as described in more detail below. Thus, in some embodiments, processor 116 can store application frameworks, kernels, libraries, drivers, application program interfaces, among others, to execute and control hardware and functions discussed herein. In some embodiments, memory 118 and/or the data storage 120 (e.g., a disk) can store similar components as processor 116 for execution by processor 116.

In the exemplary embodiment, position determination unit 122 includes hardware (e.g., sensors) and software that determine and/or acquire positional data associated with vehicle 101. For example, position determination unit 122 can include a global positioning system (GPS) unit (not shown) and/or an inertial measurement unit (IMU) (not shown). Thus, position determination unit 122 can provide location data (e.g., geo-positional data) associated with vehicle 101 based on satellite data received from, for example, a global position source unit, or from any Global Navigational Satellite infrastructure (GNSS), including, but not limited to GPS, Glonass (Russian) and/or Galileo (European). Further, position determination unit 122 can provide dead-reckoning data or motion data from, for example, a gyroscope, accelerometer, magnetometers, among other sensors (not shown). That is, position determination unit 122 may be used to determine a current location and current speed of vehicle 101. In some embodiments, position determination unit 122 can be a navigation system that provides navigation maps, map data, and navigation information to vehicle 101 to facilitate navigation of hands-free operation zones, for example.

In some embodiments, position determination unit 122 may be integrated with and/or may receive data from a plurality of sensors (not shown) used to detect the current surroundings and location of vehicle 101. Such sensors may include, but are not limited to only including, radar, LIDAR, proximity sensors, ultrasonic sensors, electromagnetic sensors, wide RADAR, long distance RADAR, Global Positioning System (GPS), video devices, additional imaging devices, additional cameras, audio recorders, and/or computer vision. The sensors may also detect operating conditions of vehicle 101, such as speed, acceleration, gear, braking, and/or other conditions related to the operation of vehicle 101, such as, for example: at least one of a measurement of the speed, direction, rate of acceleration, rate of deceleration, location, position, orientation, and/or rotation of the vehicle, and a measurement of one or more changes to the speed, direction rate of acceleration, rate of deceleration, location, position, orientation, and/or rotation of the vehicle.

Communication interface (I/F) 124 can include software and hardware to facilitate data input and output between the components of control unit 102 and other components of system 100. Specifically, communication I/F 124 can include network interface controllers (not shown) and other hardware and software that manages and/or monitors connections and controls bi-directional data transfer between communication I/F 124 and other components of system 100 using, for example, network 114. In particular, communication I/F 124 can facilitate communication (e.g., exchange data and/or transmit messages) with other vehicles and/or devices, using any type of communication hardware and/or protocols discussed herein. For example, the computer communication can be implemented using a wireless network antenna (e.g., cellular, mobile, satellite, or other wireless technologies) or road-side equipment (RSE) (e.g., Dedicated Short Range Communications or other wireless technologies), and/or network 114. Further, communication I/F 124 can also include input/output devices associated with the respective vehicle, such as a mobile device. In some embodiments described herein, communication between vehicles can be facilitated by displaying and/or receiving communication on a display within the respective vehicle.

As described above with respect to FIG. 1, vehicle systems 104 can include any type of vehicle control system and/or system that facilitates enhancing the driving experience of vehicle 101.

With reference to FIG. 3, a data flow diagram illustrates exemplary data flows through elements of system 100. Specifically, the data flow diagram illustrates how data flows in the exemplary embodiment, through control unit 102, auto driving system 106, display device 108, event camera 110, conventional camera 111, and remote server 112. Further, while the data flow diagram is described herein for use with only one event camera 110, only one conventional camera 111, one control unit 102, one remote server 112, one autonomous driving system 106, and one display device 108, it should be understood that the data flow diagram and its associated methodology can be used within a plurality of different elements of system 100. Further, it should be understood that the methodology of the data flow diagram happens continuously while vehicle 101 is in operation. Moreover, it should also be understood that system 100 may include any number of event cameras 110, conventional cameras 111, control units 102, and displays 108, for example.

In the exemplary embodiment, control unit 102 receives movement data 302 from event camera 110. Movement data 302 is received in real-time or near-real time by control unit 102. Because event camera 110 only captures data when movement of one or more objects in the surroundings of vehicle 101 is detected, event camera 110 operates at significantly greater speeds (e.g., up to 1000 Hz) than conventional camera 111. Furthermore, event camera uses very little processing power to operate and therefore operates continuously to transmit movement data to control unit 102 as vehicle 101 is operated and movement is detected.

Once movement of an object is detected by event camera 110, movement data 302 is transmitted to control unit 102 and control unit 102 analyzes the data 302 to determine whether more information is needed. In the exemplary embodiment, control unit 102 utilizes a model to analyze movement data 302 to determine if an object included in movement data 302 should be an object of interest. Objects of interest are any objects that require further information and analysis because such objects may necessitate a change in the operation of vehicle 101 and/or a change to a predetermined route. For example, objects of interest may include, but are not limited to only including, pedestrians in close proximity to vehicle 101, animals, projectiles, and any other objects that would require a controlled positive response from vehicle 101 to the object(s).

It should be noted that movement may be detected of objects that do not require a positive response from vehicle 101. Such objects are not objects of interest, and may include, but are not limited to only including leaves, trash, and/or any other small objects blowing in the wind. When movement of such objects is detected, such detection should not require a controlled positive response from vehicle 101. The model utilized by the control unit 102 may be trained utilizing machine learning and/or artificial intelligence techniques. In some embodiments, the model may also accept data inputs from a user. That is, the model may be trained utilizing historical movement data, and data about whether the historical movement data included an object of interest. The model learns from the historical movement data to detect whether an object of interest is captured in movement data 302, and control unit 102 utilizes the model to determine whether additional information about the object of interest should be retrieved. For example, if the model determines that movement data 302 received from event camera 110 is probably associated with a leaf, control unit 102 will not retrieve any additional information associated with the object. However, if the model determines that movement data 302 received from event camera 110 is most likely movement associated of an animal, control unit 102 will request additional information associated with the object of interest.

In the exemplary embodiment, control unit 102 may use a single model that has been trained or modified using historical movement data for all different terrains, route conditions, and/or weather conditions. In alternative embodiments, control unit 102 may receive input from a driver of vehicle 101, through display device 108, for example, an intended route 304 for the vehicle 101 prior to the vehicle 101 initiating operation. In such an embodiment, based on the route 304. control unit 102 may retrieve (e.g., from memory 118 and/or remote server 112, both shown in FIG. 2) information about the route 304, such as, for example, the terrain of the route, where the route passes, (e.g., through a city, through suburbs, through rural towns, primarily on a highway, local, etc.), weather conditions, and/or any other relevant information. After the route information is retrieved, control unit 102 may choose a model specific to the route information and utilize the chosen model to analyze movement data 302. Additionally or alternatively, control unit 102 may choose a model based upon a current location of vehicle 101, as received from a GPS sensor of vehicle 101, for example.

When control unit 102 analyzes movement data 302 and determines that one or more objects of interest are associated with movement data 302, control unit 102 transmits instructions 306 to conventional camera 111 to capture one or more images of the object(s) of interest. Conventional camera 111 captures images 308 as instructed by control unit 102 and transmits images 308 to control unit 102. Because conventional camera 111 only captures images 308 when instructed by control unit 102, the power required to operate conventional camera 111 is facilitated to be minimized and communication channels between control unit 102 and conventional camera 111 are utilized more efficiently, as compared to conventional camera 111 transmitting a continuous stream of images to control unit 102, which requires control unit 102 to utilize substantially more processing power to determine whether objects of interest are included in any of the continuous stream of images.

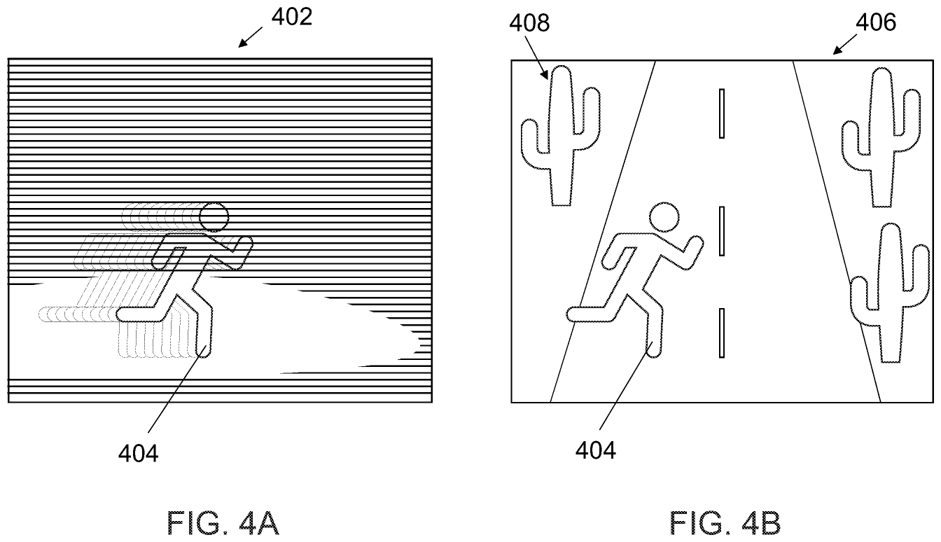

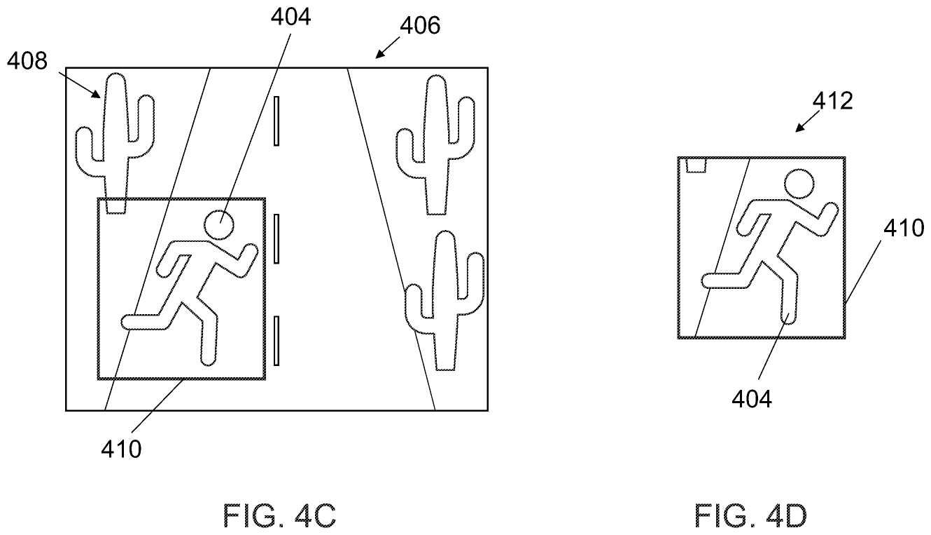

In one embodiment, control unit 102 analyzes movement data 302 and images 308 and determines whether the objects depicted in movement data 302 and images 308 are objects of interest and pose a potential risk to the vehicle, or if the objects captured in the movement data 302 do not pose any risk to vehicle 101. In another embodiment, control unit 102 transmits data 310 to remote server 112 (e.g., a cloud processing device) for further analysis of data 310 to determine whether operation of vehicle 101 needs to be changed or the route altered. Data 310 may include movement data 302, images 308, and/or a subset of movement data 302 and/or images 308. Specifically, before data 310 is transmitted to remote server 112, control unit 102 may process movement data 302 and/or images 308 such that only movement data 302 and images 308 of suspected objects of interest are transmitted to remote server 112 as data 310. For example, control unit 102 may utilize movement data 302 to crop images 308 to only include objects of interest in data 310, rather than transmitting entire images 308, as is described further herein, especially with respect to FIGS. 4A-4D. In embodiments where remote server 112 analyzes data 310 to determine whether objects depicted in data 310 are actually objects of interest, remote server 112 transmits an analysis 312 of data 310 to control unit 102. Furthermore, control unit 102 and/or remote server 112 may identify the objects of interest to determine if operation of vehicle 101 will need to be changed to avoid colliding with the objects of interest.

In the exemplary embodiment, when it is determined, by control unit 102 and/or remote server 112, that movement data 302, images 308, and/or data 310 actually include an object of interest that may cause harm to vehicle 101 in the event of a collision, control unit 102 transmits instructions 314 to autonomous driving system 106. Specifically, instructions 314 cause autonomous driving system 106 to change operation of vehicle 101 based upon the identified object of interest. For example, when the object of interest is determined to be a large piece of debris that has blown onto a road ahead of vehicle 101, control unit 102 may cause autonomous driving system 106 to swerve to avoid the debris. When the object of interest is determined to be a person or animal running in front of vehicle 101, control unit 102 may cause autonomous driving system 106 to stop before colliding with the identified person or animal. Further, control unit 102 may transmit a warning 316 to a driver of vehicle 101 through display device 108 to warn of the object of interest. For example, the warning 316 displayed on display device 108 may be accompanied by an audible alert that may alert the driver that the vehicle 101 is approaching an object of interest and/or that autonomous driving system 106 will be changing operation of vehicle 101 accordingly.

As shown and described with respect to FIG. 3, the data flow diagram illustrates how control unit 102 utilizes movement data 302 and images 308 transmitted from event camera 110 and conventional camera 111, respectively, to determine whether operation of vehicle 101 needs to be changed or altered based on objects depicted in movement data 302 and images 308. Images 308 are only captured by conventional camera 111 when the control unit 102 determines that an object of interest is included in the movement data 302. The control unit 102 transmits data 310 to remote server when a determination is made that the captured movement data 302 and/or images 308 require further analysis before determining whether the operation of vehicle 101 needs to be changed. Accordingly, as a result, the driving experience, especially for autonomous or near-autonomous vehicle operation, is enhanced while the processing power of control unit 102 and vehicle systems 104 (shown in FIG. 2) is substantially reduced and the communication channels of control unit 102 are more efficiently used.

Referring now to FIGS. 4A-D. FIG. 4A depicts exemplary movement data 402 that may be captured by event camera 110 (shown in FIG. 1) in response to an object 404 moving around or in close proximity to the vehicle 101 (shown in FIG. 1). As described in additional detail above, control unit 102 (shown in FIG. 1) may determine that object 404 is a potential object of interest, and as such, may instruct conventional camera 111 (shown in FIG. 1) to capture at least one image 406. As shown in FIG. 4B, in the exemplary embodiment, image 406 includes an object 404 and the immediate surroundings 408 of the object 404. The surroundings 408 of the object 404 are not depicted in the captured movement data 402 because no motion was detected in the surroundings 408. Accordingly, control unit 102 may determine that only the detected object 404, and not its surroundings 408, requires further analysis (e.g., by remote server 112, shown in FIG. 2) to determine whether the object 404 is an object of interest (e.g., an object that poses a risk to vehicle 101 in the event of collision with the object of interest).

As shown in FIG. 4C, the control unit 102 may process image 406 to include a cropping box 410 that fully includes object 404 while effectively minimizing its surroundings 408. Control unit 102 may crop image 406 within cropping box 410 to produce cropped image 412, shown in FIG. 4D. The cropped image 412 is then transmitted to remote server 112 to enable further analysis on cropped image 412 to determine whether object 404 is actually an object of interest. Because control unit 102 transmits only the portions of image 406 necessary for remote server 112 to analyze object 404, the processing power required for the analysis by remote server 112 is facilitated to be reduced and the communication channels between control unit 102 and remote server 112 are more efficiently utilized. As such, ultimately, the driving experience is enhanced.

The embodiments described herein relate generally to methods and systems that may be used to analyze movement data from event cameras and images from conventional cameras. In the exemplary embodiment, a control unit within a vehicle utilizes a model, generated from historical movement data, to determine, based upon captured movement data, whether at least one image of a moving object is required for further analysis. Specifically, the control unit determines whether the moving object is an object of interest that may require the operation of the vehicle to be altered to facilitate reducing the risks to the vehicle in the event of the vehicle colliding with the object. The control unit analyzes the movement data and captured images and/or transmits the captured images to a remote server for additional analysis. When it is determined that the moving object is an object of interest, the control unit transmits instructions to the vehicle to change operations of the vehicle. Accordingly, the systems and methods described herein facilitate maintaining safe autonomous vehicle operations while reducing processing power and strain on communications channels of the vehicle to analyze the surroundings of the vehicle during operation.

Exemplary embodiments of a system configured to analyze movement data and images and determine whether operation of a vehicle should be changed based upon the analysis are described above in detail. Although the system herein is described and illustrated in association with a single vehicle, the system could be used in a plurality of vehicles. Moreover, it should also be noted that the components of the disclosure are not limited to the specific embodiments described herein, but rather, aspects of each component may be utilized independently and separately from other components and methods described herein.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A vehicle comprising:
an event camera coupled to the vehicle;
a conventional camera coupled to the vehicle; and
a control unit communicatively coupled to the event camera and to the conventional camera, wherein the control unit is configured to:
receive, from the event camera when the event camera senses movement of at least one object from the surroundings of the vehicle, movement data associated with the at least one object;
instruct, based upon the movement data, the conventional camera to capture an image of the at least one object; and
analyze the movement data and the captured image to determine whether the at least one object is an object of interest.

2. The vehicle in accordance with claim 1, wherein the vehicle is capable of at least one of semi-autonomous operation and fully autonomous operation, the control unit is further configured to instruct the vehicle to change operation of the vehicle based upon a determination that an object of interest is included in the movement data and the captured image.

3. The vehicle in accordance with claim 2, wherein the control unit is further configured to cause the vehicle to at least one of stop to avoid colliding with the object of interest, swerve to avoid colliding with the object of interest, and change to a different route to avoid the object of interest.

4. The vehicle in accordance with claim 2, wherein the control unit is further configured to at least one of:
display an alert to a driver of the vehicle when the vehicle is instructed to change the vehicle operation; and
sound an audible warning to a driver of the vehicle when the vehicle is instructed to change the vehicle operation.

5. The vehicle in accordance with claim 1, wherein the control unit is further configured to communicate with a remote processing device.

6. The vehicle in accordance with claim 5, wherein the control unit is further configured to:
identify a location of the object of interest in the image based upon the movement data of the object of interest;
crop the image based on the location; and
transmit the cropped image to the remote processing device for additional analysis.

7. The vehicle in accordance with claim 1, wherein the control unit is further configured to:
utilize at least one of machine learning and artificial intelligence techniques to generate, based upon historical movement data of similar objects of interest, one or more models to determine characteristics of the historical movement data of the objects of interest that require an image of the objects of interest for further analysis.

8. The vehicle in accordance with claim 7, wherein the control unit is further communicatively coupled to a global positioning system (GPS) associated with the vehicle, and is further configured to determine a location of the vehicle based upon location data received from the GPS.

9. The vehicle in accordance with claim 8, wherein the control unit is further configured to:
receive, from a driver of the vehicle, an input of a planned route for the vehicle;
determine, based upon the location of the vehicle and the planned route, terrain and route characteristics of the planned route of the vehicle; and
select, based upon the terrain and route characteristics, a model of the one or more models to analyze the captured image.

10. The vehicle in accordance with claim 1, wherein the event camera is configured to continuously capture movement data of the at least one object in the surroundings of the vehicle.

11. The vehicle in accordance with claim 1, wherein the conventional camera is configured to capture, when instructed by the control unit, at least one image of the object of interest in the surroundings of the vehicle.

12. A vehicle sensing system of a vehicle comprising:
an event camera coupled to the vehicle;
a conventional camera coupled to the vehicle; and
a control unit communicatively coupled to the event camera and the conventional camera, wherein the control unit is configured to:
receive, from the event camera when the event camera senses movement of at least one object from the surroundings of the vehicle, movement data associated with the at least one object;
instruct, based upon the movement data, the conventional camera to capture an image of the at least one object;
analyze the movement data and the captured image to determine whether the at least one object is an object of interest; and
transmit, to a driving system of the vehicle, a signal corresponding to a determination that the at least one object is an object of interest.

13. The vehicle sensing system in accordance with claim 12, wherein the driving system of the vehicle is capable of operating the vehicle in at least one of a semi-autonomous mode and a fully autonomous mode, and wherein the control unit is further configured to instruct the driving system of the vehicle to change operation of the vehicle through the transmitted signal.

14. The vehicle sensing system in accordance with claim 13, wherein the control unit is further configured to cause the driving system of the vehicle to at least one of stop to avoid colliding with the object of interest, swerve to avoid colliding with the object of interest, and change to a different route to avoid the object of interest.

15. The vehicle sensing system in accordance with claim 13, wherein the control unit is further configured to at least one of:
display an alert to a driver of the vehicle when the vehicle is instructed to change the vehicle operation; and
sound an audible warning to a driver of the vehicle when the vehicle is instructed to change the vehicle operation.

16. The vehicle sensing system in accordance with claim 12, wherein the control unit is further configured to communicate with a remote processing device.

17. A method for enhancing operation of a vehicle, the method comprising:
receiving, by a control unit of a vehicle, from an event camera of the vehicle when the event camera senses movement of at least one object from the surroundings of the vehicle, movement data associated with the at least one object;
instructing, by the control unit, based upon the movement data, a conventional camera of the vehicle to capture an image of the at least one object; and
analyzing, by the control unit, the movement data and the captured image to determine whether the at least one object is an object of interest.

18. The method in accordance with 17, wherein the vehicle is capable of at least one of semi-autonomous operation and fully autonomous operation, and wherein the method further comprises:
instructing, by the control unit, the vehicle to change operation of the vehicle based upon a determination that an object of interest is included in the movement data and the captured image.

19. The method in accordance with claim 18 further comprising:
causing, by the control unit, the vehicle to at least one of stop to avoid colliding with the object of interest, swerve to avoid colliding with the object of interest, and change to a different route to avoid the object of interest.

20. The method in accordance with claim 18 further comprising at least one of:
displaying, by the control unit, an alert to a driver of the vehicle when the vehicle is instructed to change the vehicle operation; and
sounding, by the control unit, an audible warning to a driver of the vehicle when the vehicle is instructed to change the vehicle operation.
